(19) United States
(12) Patent Application Publication
(10) Pub. No.: US 2017/0190621 A1
(43) Pub. Date: Jul. 6, 2017

(54) Recovered hydraulic composite material and method for production thereof

(71) Applicant: Destamatic Oy, Vantaa (FI)

(72) Inventor: Asko Sarja, Espoo (FI)

(21) Appl. No.: 15/314,955

(22) PCT Filed: May 28, 2015
(86) PCT No.: PCT/FI2015/050370

§ 371 Date: Nov. 30, 2016

(30) Foreign Application Priority Data
May 30, 2014 (EP) 14170529.3

(51) Int. Cl. C04B 28/08; C04B 18/04; C04B 18/14; B09B 3/00; C04B 18/16

(52) U.S. Cl. CPC C04B 28/08; B09B 3/0041; C04B 18/16; C04B 18/14; C04B 18/04; B09B 3/00

(57) ABSTRACT

A process and method for solving the high need for a sustainable materials and good energy economy in the area of buildings and civil infrastructures in a value added and ecological way is described. The solution is a processing method and mix design of a recovered hydraulic composite material, starting from mixed construction or demolition wastes and ending into the hydraulic composite material. The raw materials of this recovery composite material comprise before adding water dominantly (90-100 mass %) recycling materials, which are processed at a concentrated plant. Waste is collected from mixed construction and demolition wastes on site and from selected byproducts of the industry. The share of construction or demolition wastes alone is more than 50 mass-% and more than 60 volume-% of the dry composite material mix. Harmful constituents are separated from the constituents of the composite in the waste treatment process. The density of the composite varies and can be specified through the mix recipe.

### TECHNICAL FIELD

The present invention concerns managing material flows of construction industry through recycling.

Especially the invention concerns method for recycling construction and demolition waste to a composite construction material and a construction material obtained by the method.

### BACKGROUND

The strategic goal of modern societies is use of sustainable technology and minimal use of limited resources, including low energy consumption and materials recycling as focus areas. Buildings and civil infrastructures are consuming highest amount of materials among all production areas. Concrete is in amount the primary construction material, and its production consumes globally a huge amount of natural gravel and sand resources for aggregate, and more than 5% of all energy used, mainly in production process of the Portland cement. The construction and demolition of old facilities produces a huge amount of waste materials which are currently mainly wasted.

Current recycling of construction and demolition wastes is most usually based on manual sorting of usable materials on each site. This requires a high amount of work and time thus consuming high costs. This is why a dominant part of these wastes are located to dump sites and only a minor part is recycled. The wasted material owns a negative economic and ecological value. Only minor part of the original waste, for example crushed concrete and tiles, steel and other metals is recycled.

Currently automated mechanical sorting processes have been applied in several countries, for example in Germany and the Netherlands. This kind of process includes usually the following phases:
breaking up the big objects of waste and particles with hammer mills or shredders,
cleaning dirty and contaminated particles by washing,
removing the ferromagnetic particles with magnetic separator,
sorting of materials based on density by air stream, hydrocyclones or centrifuging,
grading the separated materials on basis of particle size and crushing the large particles again, if necessary.

Automated mechanical waste sorting processes are presented for example in the following patent applications: CN102989747: “Solid construction waste processing and treating system”, JP2013086091: “Crushing and sorting technology” and CN102989747: “Method for realizing resourceful treatment of construction waste by adopting solid curing agent technology”. The use of waste materials in concrete has been described in the US patent applications U.S. Pat. No. 8,308,863 and US 20120276310.

The patent application U.S. Pat. No. 8,308,863 discloses a “Low embodied energy concrete mixture” and a method for making a low embodied energy cementitious mixture by blending a variety of post-consumer wastes, post-industrial wastes, as well as renewable, organic and recyclable materials with Portland cement or a material having similar cementitious properties. The primary materials are recycled concrete, coal-fired fly ash waste, silica fume, post-industrial waste, organic or inorganic waste fibers. Glass, brick, ceramics, ground tires and other waste products, as well as virgin aggregate can also be included in the low embodied energy cementitious mixture.

The patent application US 20120276310 is describes a “Extruded fiber reinforced cementitious products having wood-like properties and ultrahigh strength, and methods for making the same” and a method of manufacturing a cementitious composite including:

(1) mixing an extrudable cementitious composition by first forming a fibrous mixture comprising fibers, water and a rheology modifying agent and then adding hydraulic cement;

(2) extruding the extrudable cementitious composition into a green extrudate, wherein the green extrudate is being form-stable and able to retain a substantially predefined cross-sectional shape;

(3) removing a portion of the water by evaporation to reduce density and increase porosity; and

(4) heating the green extrudate at a temperature from greater than 65° C. to less than 99° C. Such a process yields a cementitious composite that is suitable for use as a wood substitute. Particularly, by using higher curing temperatures for preparing the cementitious building products, the building products have a lower bulk density and a higher flexural strength as compared to conventional products. The wood-like building products can be sawed, nailed and screwed like ordinary wood.

Products based on recycled materials and intended for building and construction industry are described in WO 02/34691, EP 2 647 610, US 2010/0242803 and US 2010/0058957.

### SUMMARY OF INVENTION

At the moment construction and demolition wastes are recycled in increasing amount, but quite a large amount of materials are still being deposited in waste dumps. This causes loss of resources, increased need of dumping sites and losses in usage of energy.

For the above reasons, it would be beneficial to provide a way to increase the amount of material that can be recycled to usable products in order to increase environmental sustainability of construction industry.

In a first aspect, the invention relates to a method for recycling construction and demolition waste materials to a usable product that is composed of hydraulic composite material.

One embodiment of the invention relates to centralized handling for recycling of construction and building waste materials.

One embodiment of the invention provides a product having low density compared to conventional building blocks and construction materials made of recycled materials.

One embodiment of the invention provides a way to reuse light fractions, such as wood and insulation materials, of demolition waste.

According to other aspects and embodiments of the present invention, the invention provides a method for producing for example:
products for environmental design, for example stones, plates, steps, blocks and walls for gardens,
fences and railings,
foundation blocks of buildings,
external wall panels,
noise barriers on traffic areas,
terraces of houses and restaurants, and
acoustic walls, floors and ceilings of noisy industrial production line halls

According to one further aspect of the invention, the invention provides hydraulic composite material the properties of which can be widely varied according to its intended use.

According to further one aspect of the invention, the invention provides a hydraulic composite material that has a very low environmental impact and enables effective use of recycled materials and reduces the amount of energy required for producing construction materials and products.

The invention is based on collecting construction and demolition waste materials unhandled to a processing plant, wherein the materials are sorted and graded, mixing at least part of the sorted and graded materials with hydraulic binding material so that at least 90% of the dry mass of the mixture consists of recycled materials and at most 10% consists of virgin materials from industry, the amount of hydraulic binding material being 20-30% of the dry mass of the mixture and the hydraulic binding material comprises 75-100% mass-% of recycled hydraulic industrial byproduct and at least one alkaline activator.

According to one embodiment of the invention, the amount of inert materials from construction and demolition waste materials and debris is more than 50 mass-% and more than 60 volume-% of the dry mix.

According to one embodiment of the invention, the amount of inert materials from construction and demolition waste materials and debris is more than 70 volume-% of the dry mix.

According to one embodiment of the invention the alkaline activator that is chosen from:
at most 25% of Portland cement of the dry mass of the hydraulic binding material, or
at most 5% of waterglass (Na2O.nSiO2.nH2O) of the dry mass of the binding material, or
at most 20% recycled lignosulfates of the dry mass of the binding material.

According to one embodiment, the recycled materials of the mixture comprise at least one of particles of different sizes and natural fibres (e. g. wood fibres) and for example stone or glass fibres of insulation material, all having the origin in construction or demolition wastes.

According to one embodiment, one or more chemically active or passive additives for the mixture can be chosen from: fly ash from waste burning power plants, waste kaolin clay from paper industry, silica byproduct from aluminum production and waste paper.

According to one embodiment of the invention, the product may include reinforcements, preferably chosen form: fiberglass, aramid, carbon fibre, steel as rods, cables or meshes or mixed rods or meshes.

According to one embodiment of the invention, the hardening of the product is accelerated by preheating the constituents and/or the mixture during hardening to a temperature between 40-65° C.

According to one embodiment of the invention, the density of the product is 500-2000 kg/m³.

According to one embodiment of the invention, the density of the product is between 1300-1800 kg/m3.

The embodiments of the invention provide essential benefits.

First, the invention provides an effective way to recycle at least 50% of waste materials originating from building industry and demolition sites. At present, these materials have been sorted on site. Sorting on site requires a lot of workforce and sorting results are not good as materials may get mixed leading to need for further sorting at receiving plant or rejection of the sorted load. The invention provides an increase in recycling rate and closed circle for use of materials as the materials from, for example a demolition site, can be recycled back to construction materials. Further, the invention decreases the use of energy and materials as less virgin materials are needed. Especially important is that the product according to the invention may be produces by using only small amount of Portland cement. This is beneficial as a large amount of energy used in construction industry is need for manufacturing Portland cement. This leads to decrease in carbon dioxide emissions.

One important feature of the embodiments of the invention is that it makes it possible to meet increasing governmental rules relating to recycling and deposition of waste material. As burning of waste is becoming less preferred solution in waste management and positioning any organic material in waste dumps is getting banned or expensive, this is a commercially important benefit.

The invention makes it possible to use organic materials like wood and insulation materials like stone or glass fibres for making new construction materials and products. Further, by using these materials it is possible to make products that have lower mass and density than conventional recycled products made of concrete, bricks, ceramics and other mineral debris materials. The density of the product can be modified by altering or changing the proportions of waste fractions used. For example, using more mineral based waste gives composites having higher densities wherein the volume percentages of the waste are low. The invention aims to use of high share of recycled materials. Therefore also lightweight waste fractions having low density are used. This leads to products where volumetric share of the waste is high and the density of the composite product is low.

Other objects and features of the invention will become apparent from the following detailed description considered in conjunction with the accompanying drawings. It is to be understood, however, that the drawings are intended solely for purposes of illustration and not as a definition of the limits of the invention, for which reference should be made to the appended claims.

### DESCRIPTION OF DRAWINGS

FIG. 1 shows diagram of one embodiment of the method according to the invention.

### DESCRIPTION OF EMBODIMENTS

### Definitions

Construction and demolition waste is consider to comprise all materials that can be collected from a building site during or after construction thereof or from a demolition site of a building or other large structure such as bridges or other large manmade structures.

Virgin materials from industry are considered to be any materials specifically produced to be used first time to a specific purpose.

Industrial byproducts are materials that result from manufacture of virgin materials and have no further use in the manufacturing process of the virgin material or product.

Inert materials are materials that don't participate in the binding reaction in such an extent that they would be needed to accomplish sufficient solidification of the composite product.

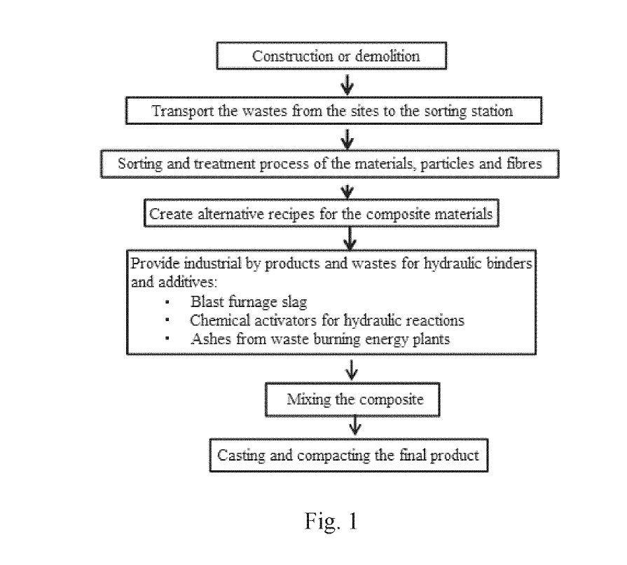

This invention aims to provide, value added and sustainable ways for the recycling a major part of the construction and demolition wastes in combination of industrial byproducts and wastes. The process begins by collection of mixed construction wastes from construction or demolition sites to a waste treatment plant. Suitable fractions of materials are then used to produce a low energy recycling composite materials and products for new constructions, the focus area of this use being the environmental structures and foundations of buildings and structures. The process is described in the following by accompanying drawing (FIG. 1).

The first step in the process is construction or demolition of a structure. The construction of a building or other large structure requires use of supporting structures such as casting moulds, scaffolding, packaging material and such. All of these materials have to be removed from the site and recycled, burned or dumped. Similarly demolition of any kind of large structure, for example a building, bridge or a chimney produces large amount of waste material that has to be handled according to governmental regulations. Sorting of these materials is rather expensive and difficult on site. Therefore the waste materials are collected and transported to a sorting station. At the sorting station the materials are sorted and graded according to the material and particle size. For this, sorting methods such as sieving, separation by compressed air, flotation, magnetism or robotic handling using machine vision may be used. In the next step, materials are selected for composite materials according to existing recipes or new recipes may be created on basis of the selection of materials currently at hand. In order to produce a hydraulic composite material from the obtained waste, a hydraulic binder is needed binding the components of the composite together. Industrial byproducts can be used for this. These include blast furnace slag, chemical activators for hydraulic reactions, ashes from waste burning energy plants etc. The hydraulic binder material may include small amounts of virgin industrial products such as Portland cement as a reactant. Industrial byproducts may also be used as additives in the hydraulic composite product. After the desired recipes has been chosen or developed and the required materials obtained, the composite can be mixed. The mixing of dry materials may be done first; whereafter water is added in order to accomplish the hydraulic binding reaction. Alternatively the mixing of water and other ingredients may be done simultaneously. After mixing, the composite is cast and compacted to final products. This stage can be done at sorting plant, at a special manufacturing plant or on site where the composite is used.

The above is a general description of one possible manufacturing workflow for producing a hydraulic composite product according to the invention. In the following more details and alternatives are presented.

The treatment of the mixed waste includes mechanical sorting of waste to different usable and unusable materials, crushing and selection of the usable material assortments, grading of these into suitable or desired particle sizes and fibres. The steps that are required for sorting and grading of the material depend on what fractions of materials the original waste includes. For example, construction waste may comprise generally wood based materials and demolished waste may be mainly concrete that included steel as reinforcement. Further common materials found in waste are insulation materials that may provide valuable fibres. The recovered materials are portioned out and mixed according to mix design recipes and mixing methods to produce hydraulic composite materials. Also the hydraulic binding material and the additives can be obtained from industrial byproducts and wastes. Collecting the unsorted waste and sorting and grading the collected waste on a sorting site makes it possible to recycle high amount (more than 50 mass-%) of the buildings demolition wastes into hydraulic composite products having quite low strength and low density. The particle size distribution and bulk characteristics of the waste can be improved and the influence of harmful agents for the hydraulic hardening processes can be eliminated by sorting and specific treatment methods like agglomeration of the waste particles. Agglomeration has the benefit that larger particles have less dust, exhibit improved flow behavior in mixing, and feature reduced sticking tendencies. Storage, handling, and feeding of materials with large particles are less risky, even for difficult materials.

The hydraulic composite material made of recycled material is obtained by using extremely high share (90-100 mass %) of recycled materials from construction and demolition sites and industrial byproducts. This provides economically added value ecological benefits.

The materials of the mixture of which the products are made may include different size particles and natural fibres (e. g. wood fibres) and for example stone or glass fibres of insulation material, all having the origin in construction or demolition wastes. The wood fibres having thickness of less than 4 mm and the length of 5-50 mm are usable. Natural fibres may be impregnated with suited chemicals, eg. with waterglass (Na2O.nSiO2.nH2O), or mineralized for example with lime slurry. In this way the bond of fibres, weathering durability and fire resistance can be improved. Light weight fractions of waste play important role in adjusting the density of the composite product. Enabling efficient use of these light weight fractions originating from wood, other organic materials, insulation materials such as glass or stone fibres or similar is one of the goals of certain embodiments of the invention.

The recycled waste used acts as inert material in the composite product and doesn't participate binding reactions for solidifying the product. Some reactivity may be inherent with some materials but binding is supposed to occur by hydraulic binding material. In other hand it may be considered that the waste fractions used act as fillers in the composite giving desired bulk for the product.

The hydraulic binding material is herein blast-furnace slag, for example, which is activated with a small share Portland cement (10-25% of the mass of the binding material), or with a minor amount of chemical activator, for example with less than 5 mass % of the mass of the binding material of waterglass (Na2O.nSiO2.nH2O), or with less than 20 mass % of the binder material of lignosulfates, or other suited alkaline activators. 75-100% of the binding material may be ground blast furnace slag. The upper limit is defined by the amount of activator used. If the amount of activator is very small, the amount of the slag is practically 100% of the binder and the activator is considered to be only an additive.

As chemically active or passive additives fly ash from waste burning power plants, waste kaolin clay waste from paper industry, waste paper and silica by product from aluminum production may be used.

For improving the workability of the composite mass chemical plasticizing agents may be used.

The waste treatment step may include mechanical waste sorting to different usable and unusable materials, crushing and selection of the usable material assortments and grading of these into suited particle grades and fibres. The materials of the mixture may include different sized particles and natural fibres (e. g. wood fibres) and for example stone or glass fibres of insulation material, all having the origin in construction or demolition wastes. The ground and sorted waste particles may be agglomerated and graded into homogenized and determined particle size grades before mixing the composite mixture.

This mixture of the recovered recycled materials is portioned out according to mix design recipes to produce specified alternatives of hydraulic composite material. The properties such as density, compressive and tensile strengths, ductility, sound absorption and easy workability of hardened composite by sawing, drilling and nailing can be controlled through mixture design. The recycled fibres may be impregnated with suitable chemicals, eg. with waterglass (Na2O.nSiO2.nH2O) or mineralized, for example, with lime slurry. Further, it is possible to accelerate the hardening process by preheating the constituents and the mixture during hardening preferably in the temperature 40-65° C. In order to obtain an attractive design, the hardened products can be finished with colouring the mixture or coating or painting the surface with suited pigments, coating agents or paints. The surface of the product may be textured during casting, for example by surface structure of a mould. Suitable manufacturing methods for obtaining the product comprise different casting and processing methods, for example casting and compacting with vibration or dumping, extrusion, pultrusion or spraying.

Specific properties which can be utilised in products made of this hydraulic composite are:
lightness: density of the product may be varied between 500-2000 kg/m³, most preferably the density is set between 1300-1800 kg/m³, as this range provides reasonable compressive strength,
effective sound absorption,
low casting pressure in moulds,
easy workability of hardened composite in sawing, drilling and nailing,
ductility and high tensile strength/compressive strength ratio,

This composite material is suited for the use especially for
environmental construction products, for example as stones, plates, steps, blocks and walls for gardens,
foundation blocks of buildings,
noise barriers on traffic areas,
terraces of houses and restaurants, and
acoustic walls, floors and ceilings of noisy industrial production line halls.

### EXAMPLES

TABLE 1
Example 1 of a mix design of the composite.

| | |
|---|---|
| CONSTITUENT | Mass % |

COMPOSITION OF THE COMPOSITE

| | | |
|---|---|---|
| Blastfurnace-slag | KJ 400 | 24 |
| Portland cement | Rapid | 7 |
| Fly ash of wood burning | 0-2 mm | 4 |
| Crushed demolition waste | 0.1-25 mm | 52 |
| Water | | 13 |

PROPERTIES OF THE COMPOSITE

| | | |
|---|---|---|
| Density | kg/m3 | 1245 |
| Compressive strength | N/mm2 | 11.9 |

Tested density and strength values of some modifications of the mix design are presented in table 2.

TABLE 2
Test results of experimental test pieces at the age of 28 days.

| Test piece | Activator | Density, kg/m3 | Compressive strength, MPa |
|---|---|---|---|
| 1 | Portland Cement | 1319 | 11.9 |
| 2 | Portland Cement | 1536 | 9.2 |
| 3 | Portland Cement | 1536 | 11.9 |
| 4 | Portland Cement | 1416 | 11.0 |
| 5 | Portland Cement | 1675 | 12.5 |
| 6 | Water glass + fly ash | 1640 | 9.6 |
| 7 | Water glass + fly ash | 1570 | 8.28 |
| 8 | Portland Cement(+wood fibres) | 1416 | 12.3 |
| 9 | Portland Cement(+stone fibres) | 1416 | 12.6 |

As can be seen from the test results, the compressive strength is quite even when the density of the product is above 1300 kg/m³ and even slightly lighter density provides good compressive strength. For practical purposes it may be reasonable to use 1300 kg/m³ as lower limit for density in order to guarantee reasonable compressive strength. However, if lighter weight is desired, it would be recommendable to test the compressive strength of the product. Portland cement seems to provide better compressive strength than waterglass and fly ash. Also, increasing the density seems to increase the compressive strength only slightly, whereby it might be reasonable to limit the density of the products below 1800 kg/m³ if the compressive strength is good enough for the intended use. Adding wood or stone fibres increases the compressive strength. As these materials are available in large quantities in construction and demolition waste, the test result is promising.

The following tables are examples for implementation of the invention illustrating the amounts and proportions of component parts both in mass and volume %. As can be seen, the volumetric share of inert demolition waste or debris is much higher than its share in mass. Thus, the density of the composite is relatively low.

TABLE 3
Examples of a mix design of the composite.
EXAMPLE 2.

| Constituents | | | Constituents | Inert building and | |
|---|---|---|---|---|---|
| of binding | Binding material, | | of the inert | demolition debris, | |
| materials | % of the dry mix | | material | % of the dry mix | |
| Mass % | Mass % | Volume % | Mass % | Mass % | Volume % |
| Blastfurnace | 40.0% | 20.7 | Mixed | 60.0% | 79.3 |
| slag 69% | | | building and | | |
| Ash of burned | | | demolition | | |
| demolition | | | debris, corn | | |
| debris 11% | | | size 0.1-25 | | |
| Virgin | | | mm, 100%. | | |
| Portland | | | | | |
| Cement 20% | | | | | |

Properties of the hardened composite

| | |
|---|---|
| Density of the hardened composite | Compressive strength of the hardened composite |
| 1245 kg/m³ | 11.9 N/mm² |

EXAMPLE 3

| Constituents | | | Constituents | Inert building and | |
|---|---|---|---|---|---|
| of binding | Binding material, | | of the inert | demolition debris | |
| materials | % of the dry mix | | material | % of the dry mix | |
| Mass % | Mass % | Volume % | Mass % | Mass % | Volume % |
| Blastfurnace | 42% | 20.7 | Mixed | 58% | 79.3 |
| slag 69% | | | building and | | |
| Ash of burned | | | demolition | | |
| demolition | | | debris, corn | | |
| debris 11% | | | size 0.1-8 | | |
| Virgin | | | mm, 82%. | | |
| Portland | | | Wood fibres | | |
| Cement 20% | | | of building | | |
| | | | and | | |
| | | | demolition | | |
| | | | debris, 18% | | |

Properties of the hardened composite

| | |
|---|---|
| Density of the hardened composite | Compressive strength of the hardened composite |
| 1416 kg/m³ | 12.3 N/mm² |

EXAMPLE 4

| Constituents | | | Constituents | Inert building and | |
|---|---|---|---|---|---|
| of binding | Binding material, | | of the inert | demolition debris, | |
| materials | % of the dry mix | | material | % of the dry mix | |
| Mass % | Mass % | Volume % | Mass % | Mass % | Volume % |
| Blastfurnace | 41% | 24% | Mixed | 59% | 76 |
| slag 68% | | | building and | | |
| Ash of burned | | | demolition | | |
| demolition | | | debris, corn | | |
| debris 13% | | | size 0.1-8 | | |
| Virgin | | | mm, 81%. | | |
| Portland | | | stone fibres | | |
| Cement 19% | | | of mineral | | |
| | | | wool of | | |
| | | | building and | | |
| | | | demolition | | |
| | | | debris, 19% | | |

Properties of the hardened composite

| | |
|---|---|
| Density of the hardened composite | Compressive strength of the hardened composite |
| 1390 kg/m³ | 12.6 N/m² |

EXAMPLE 5

| | | | Constituents | Inert building and | |
|---|---|---|---|---|---|
| Constituents, % of | Binding material, | | of the inert | demolition debris, | |
| binding materials | % of the dry mix | | material | % of the dry mix | |
| Mass % | Mass % | Volume % | Mass % | Mass % | Volume % |
| Blastfurnace slag | 45% | 20.7 | Mixed | 54.8% | 77.2 |
| 86% | | | building and | | |
| Ash of burned | | | demolition | | |
| demolition debris | | | debris, corn | | |
| 11%, | | | size 0.1-16 | | |
| chemical activator | | | mm, 91%. | | |
| solution (by | | | by product | | |
| product of paper | | | of the paper | | |
| industry) 3% | | | industry, 9% | | |

Properties of the hardened composite

| | |
|---|---|
| Density of the hardened composite | Compressive strength of the hardened composite |
| 1196 kg/m³ | 8.3 N/m³ |

As can be seen from the examples, the volumetric share of the inert building or demolition debris or waste is about 10-20% higher than its share in mass-%. This ratio is dependent on what kind of fractions the waste contains. Building or demolition waste includes mixed materials and is lighter than pure recyclables of mineral materials obtained from industry byproducts or waste.

Thus, while there have been shown and described and pointed out fundamental novel features of the invention as applied to a preferred embodiment thereof, it will be understood that various omissions and substitutions and changes in the form and details of the method and device may be made by those skilled in the art without departing from the spirit of the invention. For example, it is expressly intended that all combinations of those elements and/or method steps which perform substantially the same results are within the scope of the invention. Substitutions of the elements from one described embodiment to another are also fully intended and contemplated. It is also to be understood that the drawings are not necessarily drawn to scale but they are merely conceptual in nature. It is the intention, therefore, to be limited only as indicated by the scope of the claims appended.

1. A method for producing hydraulic composite material, comprising the steps of:
collecting unhandled construction and demolition waste materials to a processing plant,
sorting and grading the collected material to fractions at least according to material,
mixing at least part of the sorted materials with hydraulic binding material, so that at least 90% of the dry mass of the mixture consists of recycled materials and at most 10% consists of virgin materials from industry, the amount of materials from building and demolition waste being more than 50 mass-% (corresponding more than 60 volume-% of the dry mix and the amount of hydraulic binding material being 20-30% of the dry mass of the mixture and the hydraulic binding material comprising 75-100% mass-% of recycled hydraulic industrial byproduct and at least one alkaline activator.

2. The method according to claim 1, wherein the amount of materials from building and demolition waste is more than 50 mass-% and more than 60 volume-% of the dry mix.

3. The method according to claim 1, wherein the amount of materials from building and demolition waste is more than 70 volume-% of the dry mix.

4. The method according to claim 1, wherein the sorted materials from the construction and demolition waste are inert materials.

5. The method according to claim 1, wherein the hydraulic binding material comprises ground blast furnace slag and at least one alkaline activator.

6. The method according to claim 1, wherein the alkaline activator that is chosen from:
at most 25% of Portland cement of the dry mass of the hydraulic binding material, or
at most 5% of waterglass (Na2O.nSiO2.nH2O) of the dry mass of the binding material, or
at most 20% recycled lignosulfates of the dry mass of the binding material, or
mixtures thereof.

7. The method according to claim 1, wherein the recycled materials of the mixture comprise at least one of: particles of different sizes, natural fibres (e. g. wood fibres), stone or glass fibres of insulation material, all having the origin in construction or demolition wastes.

8. The method according to claim 1, wherein one or more chemically active or passive additives are added to the mixture, the additive being chosen from: fly ash from waste burning power plants, waste kaolin clay from paper industry, silica byproduct from aluminum production and waste paper.

9. The method according to claim 1, wherein reinforcements are added to the product, the reinforcements being chosen from: fiberglass, aramid, carbon fibre, steel as rods, cables or meshes or mixed rods or meshes or combinations thereof.

10. The method according to claim 1, wherein the hardening of the product is accelerated by preheating the constituents and/or the mixture during hardening to a temperature between 40-65° C.

11. The method according to claim 1, wherein the density of the product is set to 500-2000 kg/m³.

12. The method according to claim 1, wherein the density of the product is set between 1300-1800 kg/m3.

13. A hydraulic composite material, comprising recycled material and hydraulic binding material, wherein at least 90% of the dry mass of the product consists of recycled materials and at most 10% consists of virgin materials from industry, the amount of materials from building and demolition waste being more than 50 mass-% (corresponding more than 60 volume-%) of the dry mix and the amount of hydraulic binding material being 20-30% of the dry mass of the mixture and the hydraulic binding material comprising 75-100% mass-% of recycled hydraulic industrial byproduct and at least one alkaline activator.

14. The hydraulic composite material according to claim 13, wherein the amount of materials from building and demolition waste is more than 50 mass-%) and more than 60 volume-%) of the dry mix.

15. The hydraulic composite material according to claim 13, wherein the amount of materials from building and demolition waste is more than 70 volume-% of the dry mix.

16. The hydraulic composite material according to claim 13, wherein the sorted materials from the construction and demolition waste are inert materials.

17. The hydraulic composite material according to claim 13, wherein the hydraulic binding material comprises ground blast furnace slag and alkaline activator.

18. The hydraulic composite material according to claim 13, wherein the amount of the blast furnace slag is 75-100% of hydraulic binding material.

19. The hydraulic composite material according claim 13, wherein the alkaline activator that is chosen from:
at most 25% of Portland cement of the dry mass of the hydraulic binding material, or
at most 5% of waterglass (Na2O.nSiO2.nH2O) of the dry mass of the binding material, or
at most 20% recycled lignosulfates of the dry mass of the binding material, or
mixtures thereof.

20. The hydraulic composite material according to claim 13, wherein the recycled materials of the mixture comprise at least one of: particles of different sizes, natural fibres (e. g. wood fibres), stone or glass fibres of insulation material, all having the origin in construction or demolition wastes.

21. The hydraulic composite material according to claim 13, further comprising one or more chemically active or passive additives being chosen from: fly ash from waste burning power plants, waste kaolin clay from paper industry, silica byproduct from aluminum production and waste paper.

22. The hydraulic composite material according to claim 13, further comprising reinforcements added to the product, the reinforcements being chosen form: fiberglass, aramid, carbon fibre, steel as rods, cables or meshes or mixed rods or meshes or combinations thereof.

23. The hydraulic composite material according to claim 13, wherein the density of the product is 500-2000 kg/m3.

24. The hydraulic composite material according to claim 13, wherein the density of the product is between 1300-1800 kg/m³.

25. A hydraulic composite product produced by:
collecting unhandled construction and demolition waste materials to a processing plant,
sorting and grading the collected material to fractions at least according to material,
mixing at least part of the sorted materials with hydraulic binding material, so that at least 90% of the dry mass of the mixture consists of recycled materials and at most 10% consists of virgin materials from industry, the amount of materials from building and demolition waste being more than 50 mass-% (corresponding more than 60 volume-% of the dry mix and the amount of hydraulic binding material being 20-30% of the dry mass of the mixture and the hydraulic binding material comprising 75-100% mass-% of recycled hydraulic industrial byproduct and at least one alkaline activator.

26. The hydraulic composite product according to claim 25, the product being any of the following:
environmental product, such as stone, plate, step, block or wall for gardens,
fence and railing,
foundation block for buildings,
external wall panel,
noise barrier on traffic areas,
terrace for houses and restaurants, or
acoustic wall, floor or ceiling for noisy industrial production line halls.
